(19) United States
(12) Patent Application Publication
(10) Pub. No.: US 2026/0036864 A1
(43) Pub. Date: Feb. 5, 2026

(54) ACTIVE DISPLAY INTERIOR VEHICLE SURFACES

(71) Applicant: The Boeing Company, Arlington, VA (US)

(72) Inventor: Edward Ryan GREENE, North Charleston, SC (US)

(73) Assignee: The Boeing Company, Arlington, VA (US)

(21) Appl. No.: 19/353,329

(22) Filed: Oct. 8, 2025

Related U.S. Application Data
(63) Continuation-in-part of application No. 18/528,229, filed on Dec. 4, 2023, now Pat. No. 12,479,578.

(51) Int. Cl. G02F 1/1676; B64D 11/00; G02F 1/167; G02F 1/1677; G09G 3/20; G09G 3/34

(52) U.S. Cl. CPC G02F 1/1676; B64D 11/0015; G02F 1/167; G02F 1/1677; G09G 3/2092; G09G 3/3446; B64D 2011/0061; G09G 2380/12

(57) ABSTRACT

Techniques for providing a display inside a vehicle are presented. The techniques can include: providing an electrophoretic surface integrated into an internal component of the vehicle, where the electrophoretic surface is flame resistant, and where the electrophoretic surface is configured to display an image within the vehicle; and controlling the electrophoretic surface using an electronic controller communicatively coupled to the electrophoretic surface.

### REFERENCE TO RELATED APPLICATIONS

This application is a continuation-in-part of and claims priority to U.S. Ser. No. 18/528,229, filed on Dec. 4, 2023, which is hereby incorporated by reference in its entirety.

### FIELD

This disclosure relates generally to vehicle, such as aircraft, and to electronic displays.

### BACKGROUND

Electrophoretic displays create images through electrostatic manipulation of pigment within microscopic capsules dispersed in a substrate. Each capsule is typically filled with hydrocarbon oil, which may be dyed to be opaque. Each capsule also includes a small amount of pigment particles of one or more colors and corresponding electrical charge(s). The substrate is sandwiched between electrodes that effectuate the electrostatic manipulation of the pigment particles within the capsules. The front electrode, on the side of the viewer of the display, is typically transparent or translucent. The back electrode may be divided up according to addressable pixels, and appropriate voltages may be applied between the pixel electrodes and the front electrode to form an image on the display. The pigment particles migrate electrophoretically between the front of the capsule (facing the viewer) and the back of the capsule (away from the viewer) according to the electrostatic manipulation provided by the electrodes. When pigment particles of a particular color (and charge) are at the front of the capsule, their color is visible to the viewer. Conversely, when pigment particles of a particular color are at the back of the capsule, the capsule as viewed from the front of the display takes on the color of the opaque oil and/or the color of any particles of a different color (and charge) that are at the front of the capsule. Thus, various colors may be displayed according to specific charge manipulations.

Electronic displays are most commonly implemented using LED or LCD technology. Such displays may be are capable of changing content on demand, but they require significant power, are large in footprint, and have inconsistent visibility under differing observation conditions (e.g., ambient brightness).

Vehicles, such as aircraft, may include various displays. However, pilots have limited visibility during ground operations and must rely on ground crews for situational awareness. Further, trends toward increased seat density have led to passenger dissatisfaction at being confined while onboard an aircraft. Paper menus may be passed out and collected, passengers often scramble to exit the plane to learn of connecting flights, and there is often tension between passengers who may wish to look out the window on a long flight and passengers annoyed by the very bright sunlight shining in.

### SUMMARY

According to various embodiments, a system for providing a display inside a vehicle is presented. The system includes: an electrophoretic surface integrated into an internal component of the vehicle, where the electrophoretic surface is flame resistant, and where the electrophoretic surface is configured to display an image within the vehicle; and an electronic controller communicatively coupled to the electrophoretic surface.

Various optional features of the above system embodiments include the following. The electrophoretic surface may include an electrophoretic film. The electrophoretic surface may include an electrophoretic coating. The vehicle may include an aircraft, and the component may include at least one of: a cabin wall, a luggage bin, a seatback, a portion of a flight deck, a cabin floor, a divider between aircraft sections, a cabin ceiling, an overhead bin, a lavatory interior, a lavatory door, a tray cart surface, a seat back, a tray table, a window shade, or an overhead area. The system may further include a camera communicatively coupled to the controller, where the electrophoretic surface is configured to display an image captured by the camera. A field of the view of the camera may include an area outside of the vehicle. The vehicle may include an airplane, where the field of view includes an area beneath a wing of the aircraft, where the electrophoretic surface is positioned above the wing of the aircraft, and where the electrophoretic surface displays an image of the area beneath the wing of the aircraft unobstructed by the wing. The vehicle may include an airplane, where the field of view includes an area above the aircraft, and where the electrophoretic surface is configured to display an image of the area above the aircraft. The electrophoretic surface may be configured to provide a virtual window on the airplane. A field of view of the camera may include an area inside of the vehicle.

According to various embodiments, a method of providing a display inside a vehicle is presented. The method includes: providing an electrophoretic surface integrated into an internal component of the vehicle, where the electrophoretic surface is flame resistant; providing an electronic controller communicatively coupled to the electrophoretic surface; and displaying an image, by the electrophoretic surface, within the vehicle.

Various optional features of the above method embodiments include the following. The electrophoretic surface may include an electrophoretic film. The electrophoretic surface may include an electrophoretic coating. The vehicle may include an aircraft, and the component may include at least one of: a cabin wall, a luggage bin, a seatback, a portion of a flight deck, a cabin floor, a cabin overhead area, or a divider between aircraft sections. The image may be captured by a camera communicatively coupled to the controller. A field of the view of the camera may include an area outside of the vehicle. The vehicle may include an airplane, where the field of view includes an area beneath a wing of the aircraft, where the electrophoretic surface is positioned above the wing of the aircraft, and where the image is of the area beneath the wing of the aircraft and unobstructed by the wing of the aircraft. The vehicle may include an airplane, where the field of view includes an area above the aircraft, and where the image is of the area above the aircraft. The electrophoretic surface may be configured to provide a virtual window on the airplane. A field of view of the camera may include an area inside of the vehicle, and the image may be of the area inside of the vehicle.

Combinations, (including multiple dependent combinations) of the above-described elements and those within the specification have been contemplated by the inventors and may be made, except where otherwise indicated or where contradictory.

### BRIEF DESCRIPTION OF THE DRAWINGS

Various features of the examples can be more fully appreciated, as the same become better understood with reference to the following detailed description of the examples when considered in connection with the accompanying figures, in which:

FIG. 1 illustrates an electrophoretic surface display inside an aircraft, according to various embodiments;

FIG. 2 illustrates an electrophoretic surface display inside an aircraft, according to various embodiments;

FIG. 3 illustrates an electrophoretic surface display inside an aircraft, according to various embodiments;

FIG. 4 is a schematic diagram of an electrophoretic surface display system inside a vehicle, according to various embodiments; and

FIG. 5 is a flow diagram of a method for providing an electrophoretic surface display inside a vehicle, according to various embodiments.

FIGS. 6A-6B are schematics depicting a cross-sectional diagram of the operation of electrophoretic displays, according to various embodiments.

FIGS. 7A-7B are schematics depicting exemplary examples of electrophoretic displays, according to various embodiments.

FIG. 8 illustrates a schematic view of a vehicle, an application of one or more electrophoretic displays applied to an aerospace vehicle, in accordance with the present disclosure.

It should be noted that some details of the figures have been simplified and are drawn to facilitate understanding of the present teachings rather than to maintain strict structural accuracy, detail, and scale.

### DESCRIPTION OF THE EXAMPLES

Reference will now be made in detail to example implementations, illustrated in the accompanying drawings. Wherever convenient, the same reference numbers will be used throughout the drawings to refer to the same or like parts. In the following description, reference is made to the accompanying drawings that form a part thereof, and in which is shown by way of illustration specific exemplary examples in which the invention may be practiced. These examples are described in sufficient detail to enable those skilled in the art to practice the invention and it is to be understood that other examples may be utilized and that changes may be made without departing from the scope of the invention. The following description is, therefore, merely exemplary.

Some embodiments integrate electrophoretic display surfaces into interior components of an aircraft. According to various embodiments, the electrophoretic display surfaces may include electrophoretic films and/or electrophoretic coatings. Embodiments that utilize electrophoretic displays can hold their appearance with no power required until the display is changed. Consequently, such embodiments require far less power than traditional LED or LCD displays. According to various embodiments, one or more electrophoretic display surfaces on a flight deck of an aircraft may allow pilots to turn their heads and virtually see-through the aircraft fuselage for improved ground handling safety. According to various embodiments, one or more electrophoretic display surfaces in the passenger cabin of an aircraft may be used to create virtual passenger windows and/or virtually transparent or simulated scenes on walls, floors, overhead areas, and/or other aircraft components. According to various embodiments, optical illusions, much like a large wall mirror in a restaurant, can be provided for more open and less confining cabin feel. According to various embodiments, electrophoretic display surfaces may be used for functional purposes, such as serving as a mirror for a passenger, displaying a meal menu, displaying personalized connecting flight information, or helping a passenger find their seat. According to various embodiments, electrophoretic display surfaces may be used to provide decorative images, such as artwork. Thus, according to various embodiments, electrophoretic display surfaces on the interior of an aircraft may improve pilot visibility, alleviate passenger dissatisfaction, and/or provide passenger information.

In examples, the electrophoretic display surfaces of the present disclosure can include multiple-layered structures that provide special effect displays, incorporating reflective, glitter, or sparkle effects of one or more colors or combinations of the one or more effects. These special effects can be dependent on, or a result of the incorporation of electrophoretic micro-flakes suspended in fluid media suspended between various electrode layers or other surface layers of the electrophoretic display surfaces. The top surface, or outermost surface, i.e. the surface closest to a viewing position is typically comprised of a top plane, transparent electrode material, such that the underlying layers and any effects created with or displayed upon the electrophoretic display surface can be visible. The electrophoretic display surfaces also include a bottom plane electrode. This may or may not be transparent, but is typically not required to be so. In examples, there can be a middle plane electrode that controls the viewing condition of one or more populations of electrophoretic materials or electrophoretic micro-flakes. Voltage can be applied to one or more electrodes to control rotation or flake proximity to an outer surface of the one or more electrophoretic display surface. In examples, multiple special effect appearances can be enabled by a single electrophoretic film, or alternatively with the use of multiple, overlapping electrophoretic films. Examples of the present disclosure can also include a TFT backplane for individually addressable pixel definition or patterned electrodes for segmented display applications.

These and other features and advantages are shown and described herein in reference to the accompanying figures.

Note that although various embodiments are illustrated in reference to aircraft such as commercial airplanes, embodiments are not so limited. In general, embodiments may be used on interior surfaces of any vehicle, including by way of non-limiting example, rotary-wing aircraft such as helicopters, trains, automobiles, and tractor-trailer trucks.

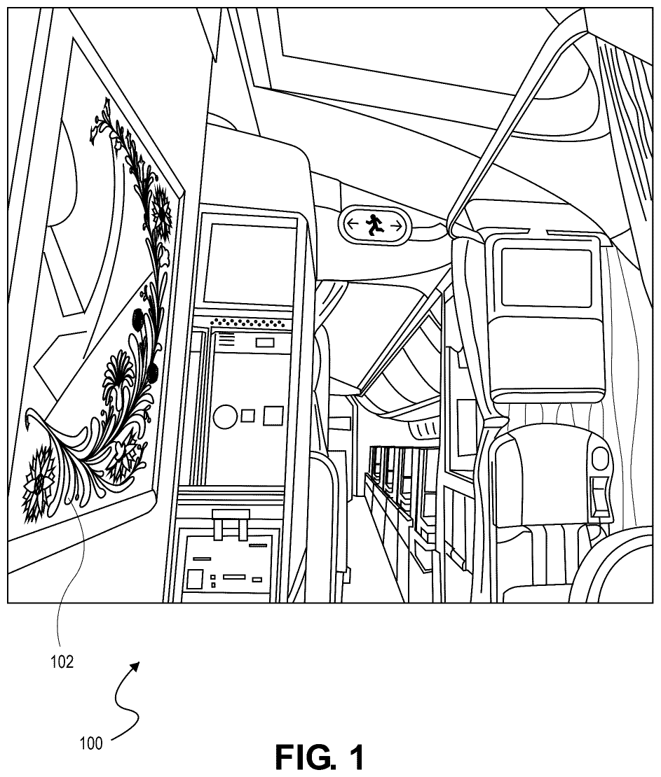

FIG. 1 is an illustration 100 an electrophoretic surface display 102 inside an aircraft, according to various embodiments. The electrophoretic surface display 102 is shown as being integrated into the surface of an aircraft component, namely, a passenger cabin wall. Although shown as being bounded by a decorative frame, embodiments are not so limited. For example, the electrophoretic surface display 102 may be implemented without a frame such that it can seamlessly blend into the aircraft component in which it is integrated. According to various embodiments, the electrophoretic surface display 102 may be implemented using an electrophoretic film that conforms to the shape of the component surface, or an electrophoretic coating, which may be applied to the surface of the aircraft component. Note that the electrophoretic surface display 102 may not require power once an image is displayed. Instead, the electrophoretic surface display 102 may continue to show an image without requiring any power. Power may be applied in order to change a displayed image to a different image for display. Further, the electrophoretic surface display 102 may not emit light, such that it may resemble a printed image, and the image presented on electrophoretic surface display 102 may be visible in any ambient light condition, including in the presence of full sunlight.

According to various embodiments, the electrophoretic surface display 102 may be flame resistant. According to some embodiments, instead of a flammable hydrocarbon oil filling the capsules in the electrophoretic surface display 102, a different, flame-resistant liquid may be used. Such liquid may be an anionic flame-resistant fluid, for example. In addition, or in the alternative, according to some embodiments, the electrophoretic surface display 102 may be covered on the front and/or back by one or more types of flame-resistant film, e.g., thin glass. For example, according to some embodiments, the electrophoretic surface display 102 may be sandwiched between such flame-resistant films.

The electrophoretic surface display 102 may be integrated into any component of the aircraft. By way of non-limiting examples, the electrophoretic surface display 102 may be integrated into a cabin wall, a luggage bin, a seatback, a portion of a flight deck, a cabin floor, a cabin overhead area, or a divider between aircraft sections.

The electrophoretic surface display 102 may display any of a variety of informational and/or decorative images. For example, the electrophoretic surface display 102 may display any, or any combination, of: a meal menu, connecting flight information, signage, advertisements, or decorative images such as artwork or optical illusions. The electrophoretic surface display 102 may be present on any surface of the airplane to show images in proximity to individual or groups of passengers, e.g., on the cabin wall, floor, ceiling, overhead bin, lavatory interior or door, tray cart surfaces, seat back, tray table, window shades, or overhead area. Images may also be individualized, such as, by way of non-limiting examples: personalized food menus, personalized connecting flight information, personalized advertisements, personalized messages, personalized flight status (e.g., for connecting flights), personalized frequent flier status, and/or personalized passenger identifications, which may be anonymized. Images may be dynamic. For example, a electrophoretic display may display a beach scene, with gentle waves lapping at the sand.

According to some embodiments, the electrophoretic surface display 102 may be communicatively coupled to one or more cameras, positioned to have field(s) of view inside and/or outside of the aircraft, and may display images captured by the camera(s).

Examples that utilize one or more cameras having field(s) of view inside the aircraft are discussed presently. For example, the electrophoretic surface display 102 may show images of the interior of the cabin, in analogy to a large mirror in a restaurant, so as to make the cabin appear larger than it is. As another example, the electrophoretic surface display 102 may act as a personal mirror and show an image of a particular passenger on a cabin wall next to the passenger, e.g., upon activation by the passenger. As yet another example, the electrophoretic surface display 102 may be integrated into a divider between sections of the aircraft cabin, and, when the aircraft is stationary, for example, may appear transparent by displaying, on one side of the barrier, the field of view on the other side of the barrier, and vice versa. According to such embodiments, the electrophoretic surface display 102 may display other images, or no images so as to appear opaque, when the aircraft is in motion.

Examples that utilize one or more cameras with field(s) of view outside of the aircraft are discussed presently. According to some embodiments, the electrophoretic surface display 102 may act as a virtual window of the aircraft, and allow passengers and/or pilots to virtually see through the fuselage to view images of one or more fields of view outside the aircraft. According to this example, the fields of view may include areas over the aircraft, under the aircraft, and/or next to the aircraft. That is, for such embodiments, the electrophoretic surface display 102 may be integrated on the floor of the aircraft and display a field of view under the aircraft, be integrated in the cabin wall and display a field of view next to the aircraft, and/or be integrated on the overheard area of the aircraft and display a field of view over the aircraft. Such embodiments in the floor may, for example, display a moving (e.g., real time) view of the ground from the viewpoint of the high-altitude aircraft, potentially showing clouds beneath the aircraft in addition or in the alternative. Such embodiments in the wall or ceiling may, for example, show clouds during the day and stars during the night. According to some embodiments, the fields of view may include areas under one or more wings of the aircraft, and the electrophoretic surface display 102 may be positioned between a direct line from such areas to an aircraft occupant, such that the aircraft occupant may be able to virtually see through the cabin wall and aircraft wing and see the field of view below the wing displayed on the electrophoretic surface display 102. Note that embodiments according to this paragraph advantageously allow aircraft occupants to view outside, without permitting harsh sunlight to enter through the display surfaces.

Embodiments are not limited to the example images expressly disclosed herein. Other images, whether originating from the field(s) of view of one or more cameras or not, fall within the scope of the invention.

Embodiments may present one or more safety advantages. For example, electrophoretic displays that are readily viewable by passengers provide for immediate communication, which may be important in emergency situations. As another example, electrophoretic displays that may ordinarily show decorative images may be repurposed to display information, e.g., in an emergency. As yet another example, electrophoretic displays can provide information to passengers while the passengers remain seated, thereby reducing aisle congestion, which may increase safety. As yet another example, displaying decorative images may have the effect of soothing stressed passengers.

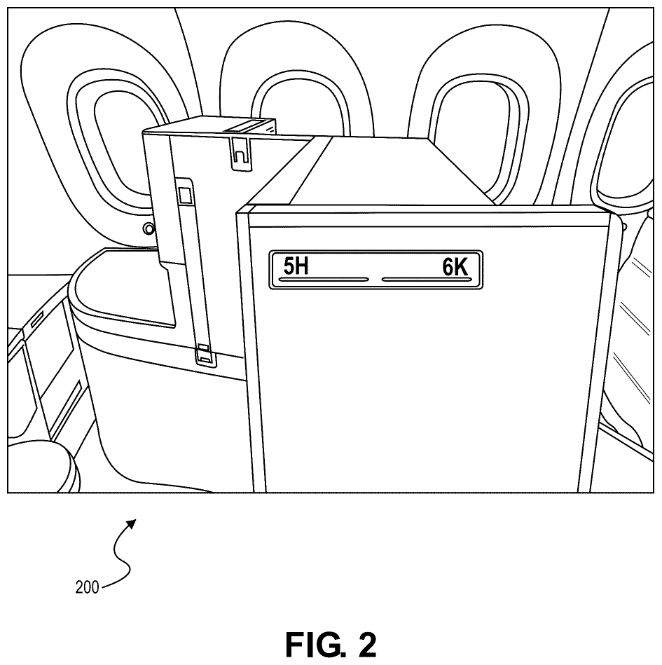

FIG. 2 illustrates an electrophoretic surface display 200 inside an aircraft, according to various embodiments. As shown in FIG. 2, the electrophoretic surface display 200 includes aircraft cabin placarding. Such embodiments may allow an airline to change placarding depending on the route that it is flying. For example, the route between Los Angeles and Japan could have English and Japanese placards, whereas the placarding in the same aircraft scheduled for Los Angeles to Soul may be changed to have English and Korean instructions.

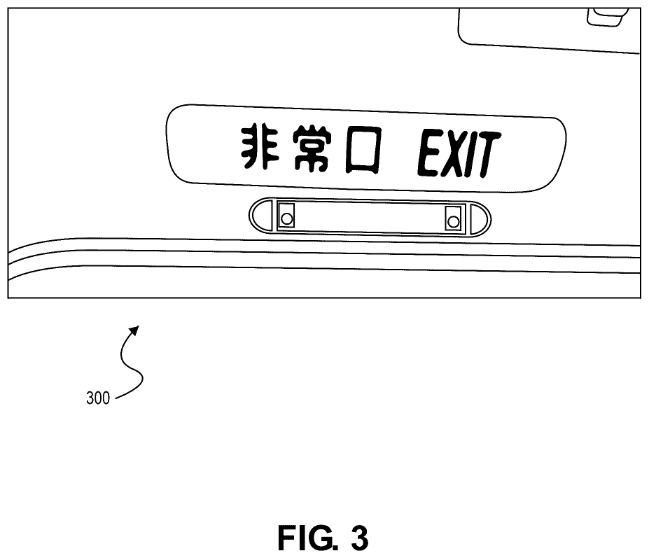

FIG. 3 illustrates an electrophoretic surface display 300 inside an aircraft, according to various embodiments. In particular, FIG. 3 illustrates another example of aircraft placarding. The electrophoretic surface display 300 is shown as being integrated into an aircraft panel, e.g., such that the rear electrode arrow of the electrophoretic surface display 300 is in contact with the aircraft cabin wall component. Note that embodiments such as are illustrated according to FIG. 3 have the benefit of being able to change functional information in the aircraft itself, as shown in FIG. 3, an exit location, and may continue to display such functional information in an emergency situation when power is lost. This presents a clear advantage over changeable displays based on LED or LCD technology.

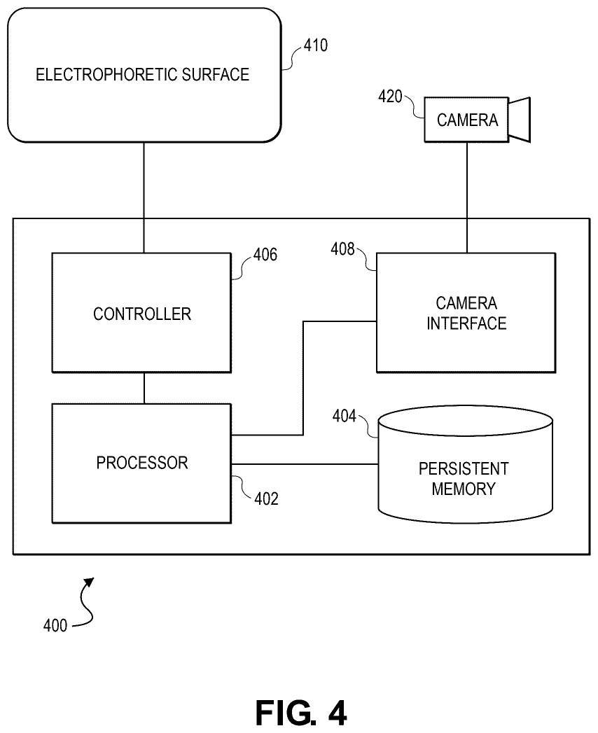

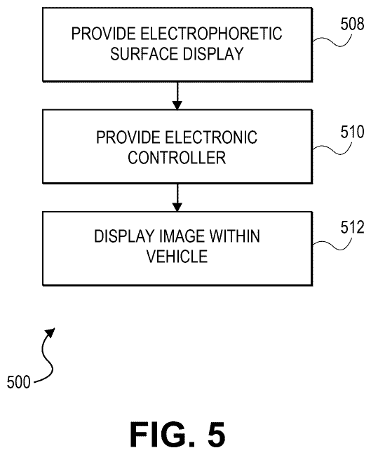

FIG. 4 is a schematic diagram of an electrophoretic surface display system 400 inside a vehicle, according to various embodiments. The system 400 may be used to display any image, including, but not limited to, those shown and described herein in reference to FIGS. 1-3. In particular, the system 400 may be used to display one or more images on the included electrophoretic surface display 410. The system 400 includes an electronic processor 402 communicatively coupled to an electronic non-transitory persistent memory 404. The persistent memory 404 can store program instructions which, when executed by the electronic processor 402, may configure the electronic processor 402 to perform actions as disclosed herein, e.g., as shown and described in reference to FIG. 5. The persistent memory 404 may store data representing images that may be displayed by the system 400 as disclosed herein. The system 400 also includes an electronic controller 406 communicatively coupled to the electronic processor 402. The electronic controller 406 provides electronic signals to the electrophoretic surface display 410. Such electronic signals activate the electrodes of the electrophoretic surface display 410 to remove or erase one or more current image(s) and present or display one or more different image(s), in some instances images captured by the camera 420, and communicated through the camera interface 408. Images presented on the electrophoretic surface display 410 may originate from data stored in the persistent memory 404 or from a field of view of the one or more communicatively coupled camera(s) 420.

FIG. 5 is a flow diagram of a method 500 for providing an electrophoretic surface display inside a vehicle, according to various embodiments. The method 500 may be implemented using a system, such as the system 400 as shown and described herein in reference to FIG. 4. The method 500 may be used to display any image, including, but not limited to, those shown and described herein in reference to FIGS. 1-3.

At 512, the method 500 includes providing an electrophoretic surface integrated into an internal component of the vehicle. The electrophoretic surface may be provided as shown and described in reference to any of FIGS. 1-3, for example. The electrophoretic surface may be flame resistant, as described herein.

At 510, the method 500 includes providing an electronic controller communicatively coupled to the electrophoretic surface. The electronic controller may be implemented as shown and described herein in reference to FIG. 5, e.g., in reference to the electronic controller 406.

At 508, the method 500 includes displaying an image, by the electrophoretic surface, within the vehicle. The image may be displayed as shown and described in reference to any of FIGS. 1-3, for example. For example, the image may originate from stored data representing the image, and/or from a field of view from one or more communicatively coupled cameras.

According to the present disclosure, the electrophoretic micro-flakes suspended in fluid are a component of the present disclosure that enables dynamic control over special effects on decorative surfaces. These particles, with diameters, or a dimension in one direction, ranging from 0.5-100 micrometers are dispersed within an electrically conductive liquid, such as water or glycerin-based solution. When voltage is applied across the electrodes, these flakes move towards one electrode and away from another due to electro-osmotic forces, allowing for controlled movement of particles on a surface. The size and shape of the top plane electrode may be tailored according to specific applications, with larger sizes suitable for large-scale displays or decorative surfaces, while smaller ones may be more effective in small-area applications like logos or icons. It should be noted that the flakes can be induced to rotate within the suspended fluid such that a reflective flake material can produce a sparkle, glitter, or reflective effect when rotating or at particular angles when rotated to a specific angle relative to a plane of a surface of the electrophoretic display. The electrophoretic micro-flakes can be customized according to operating parameters or customer preferences by adjusting particle size distribution, color pigmentation, viscosity levels, or other parameters.

In the present teachings, the electrophoretic layer can have a charge induced, and thus, the orientation of the flake material can change within the fluid media, and create a special effect, such as, but not limited to, a sparkle effect, a glitter effect, or a shimmer effect. Sparkle and Graininess are example parameters used when measuring special effects with an instrument called BYK-mac, obtainable from BYK-Gardner, Geretsried, Germany. In response to an electric field, these electrophoretic particles move when subjected to an electric field. Charge moves flakes and directs orientation to create a variable reflectance. These electrophoretic materials can be rectangular or other-shaped flakes that can be any color. Likewise, the fluid media can be colored or colorless.

In contrast to electrophoretic films that change color when subjected to a magnetic field, the electrophoretic film of the present disclosure changes orientation of the flakes, causing the appearance of the film to display one or more of the following effects: shimmering, particle rotation, flickering, reflecting, and the like. In examples, the cycling of rotation or power can be conducted to move flakes in either a synchronized fashion based on charging, or alternatively moved or rotated randomly or asynchronously. In addition, a mixture of particle size of flakes or rotatable particles can be used to create novel special effects within the electrophoretic film or display. In different spatial areas across a surface of the electrophoretic display, an effect that is induced by the electric field can include variable reflectance. In other examples, a front-lit display or a back-lit display can be used with a translucent or transparent display surface to provide a certain effect, as well as providing a filter in one or more layers to change color or provide other appearance effects. In still other examples, a dyed fluid media or silhouette type image can be used to portray certain static features of the electrophoretic displays described herein. In still other examples, voltage can be induced within one or more layers of an electrophoretic display, the level of induced voltage can be maintained for a period of time, providing continuous rotating of the electrophoretic material to create a sparkle effect. At other times the stoppage of inducing voltage can be done and the electrophoretic material can hold in place or in space to stop or hold the effect.

The fluid can further influence the behavior of these micro-flakes as it affects their movement by controlling viscosity levels that influence flake rotation speed and proximity to the surface when an electric current is applied. Thicker fluids may create slower-moving flakes for a more subtle effect, while thinner liquids enable faster movements with increased sparkle intensity over a specific duration, or indefinitely, depending on the state of the rotation of the plurality of electrophoretic flake materials.

The electrophoretic micro-flakes suspended in fluid can allow multiple colors or effects to be displayed simultaneously on a single decorative surface by controlling the voltage levels, frequencies, or combinations of both applied across different areas. This technology also enables unique branding opportunities for customers as it may change logos, messages, or design elements during flight operations without requiring replacement of entire aircraft surfaces.

Furthermore, these micro-flakes and fluid composition may be customized according to customer preferences or brand identities by adjusting particle size distribution, color pigmentation, viscosity levels, and other parameters as described herein. This customization enables branding opportunities for companies or customers. The integration or blending of electrophoretic micro-flakes with other electrophoretic materials offer flexibility, adaptability, and dynamic control over special effects on decorative surfaces.

The top, and in some examples, transparent, plane electrode of this electrically tunable special effect film is integral in controlling the movement and proximity of electrophoretic micro-flakes on a surface. This transparent layer serves as an interface between the fluid containing the flakes and the surrounding environment, allowing light to pass through, or be cast upon it from an external position, while enabling precise control over flake rotation speed and distance from the surface when voltage of a controlled level is applied across it. The size and shape of this electrode may be tailored according to specific application requirements; larger electrodes may be suitable for large-scale displays or decorative surfaces, whereas smaller ones might be more effective in small-area applications such as logos or icons.

The transparent top plane electrode does not necessarily affect the overall appearance of special effects displayed on decorative surfaces but rather facilitates uniform illumination by allowing light to pass through while controlling flake movement and proximity. This design provides a seamless integration with various display technologies, including LED lights or OLED displays, for added visual complexity by layering films or integrating them into larger designs. In other examples, filters or other layers can provide a specific color, anti-reflective, or other functional surface over the external transparent surface of electrophoretic displays of the present disclosure. Alternatively, while not necessarily a filter, a transparent light guide can be added on top of one or more of the electrophoretic films such that the effect can be front lit and illuminated from an LED source for an improved sparkle appearance.

The transparent top plane electrode can be configured to be flexible and adaptable to different surface geometries, allowing it to accommodate multiple decorative surfaces such as fuselage, wings, control surfaces, cabin walls, ceilings, and the like. The ability to adjust voltage levels across this electrode enables multiple special effect appearances in a single film, including glitter effects with various colors or patterns.

Furthermore, the transparent top plane electrode can provide optimal viewing angles during nighttime operation by minimizing glare from surrounding light sources that may affect visibility of decorative surfaces comprising this technology. The transparency of the top layer, even if colored or comprising a filter, can allow it to be used as part of multi-layered designs where different levels of opacity and color intensity may be achieved through controlled movement and proximity of micro-flakes within individual layers.

The bottom plane electrode provides control of the movement and proximity of electrophoretic micro-flakes on a surface, or more accurately, within the fluid media space between electrodes. This transparent or opaque layer may be configured to accommodate various shapes, sizes, and configurations depending on its intended application. In some instances, multiple bottom plane electrodes may be used to create segmented display effects by applying different voltages across each electrode segment, offering increased flexibility in customization options compared to using patterned electrodes alone. The choice of material for the bottom plane electrode is also useful as it affects not only its functionality but also potential interactions with other components within the film.

The voltage applied to electrodes contributes to controlling the rotation and proximity of electrophoretic micro-flakes on a surface. When an electric current is introduced across the transparent top electrode and bottom plane electrode, it generates electro-osmotic forces that influence the movement of these tiny particles suspended within a fluid medium. The strength and direction of this force depend directly upon the voltage levels applied to each electrode. As the voltage increases or decreases, the micro-flakes rotate in response by moving closer together or away from one another, or move away from or move towards an electrode depending on their initial position. This controlled movement enables multiple special effect appearances within a single film, allowing for dynamic customization of decorative surfaces and improved visibility under various lighting conditions.

The relationship between voltage levels and flake rotation in some examples can be non-linear, with the distance between electrodes decreasing as the applied voltage increases. For example, when using patterned electrodes to create segmented displays or logos, different voltages may be used across each segment to control particle movement independently within a single film. This flexibility can offer useful customization options for various applications. For example, the level or amplitude of or cycling of voltage could be non-constant, or could change, thereby changing the dynamic appearance or “speed” of a glitter or sparkle effect.

In addition to decorative surfaces on aircraft, this technology has possible applications in consumer electronics, automotive design, fashion accessories, architectural materials, or even medical devices for visual therapy purposes. By controlling micro-flake movement using an electric current, multiple patterns may be displayed simultaneously within a single film without requiring separate displays, offering increased flexibility and customization options.

The TFT backplane and patterned electrode configurations in this electrically tunable special effect film can provide individually addressable pixel definition or segmented display applications with useful versatility, particularly when used to employ special effects as noted herein. The electrodes, in conjunction with the TFT backplane, can enable individually addressable pixel definition at resolutions ranging from 100-200 dpi, allowing for intricate display patterns or logos to be programmed on demand. The patterned electrode configuration offers an alternative approach by segmenting the film into distinct areas that may be controlled independently using different voltage levels, frequencies, or combinations of both. This feature enables complex designs with varying levels of transparency, color intensity, and pattern complexity through precise control over particle movement within each layer.

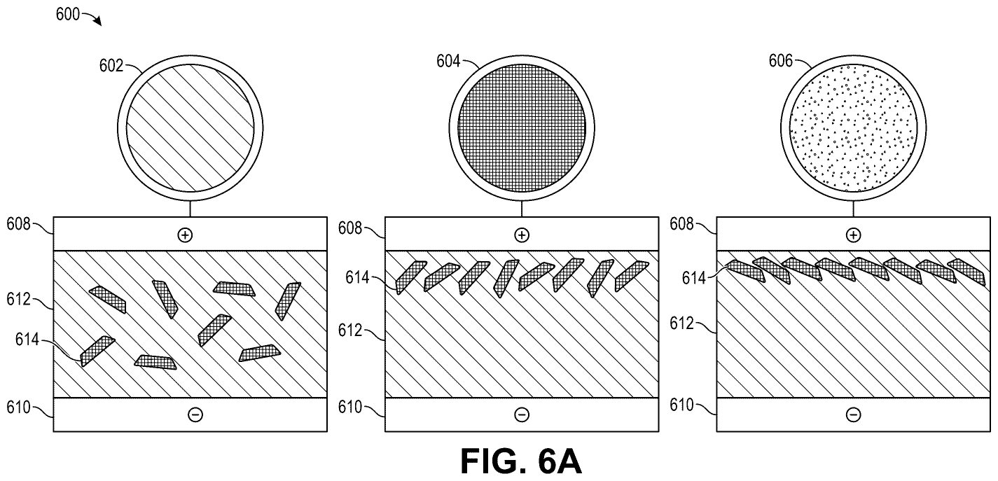

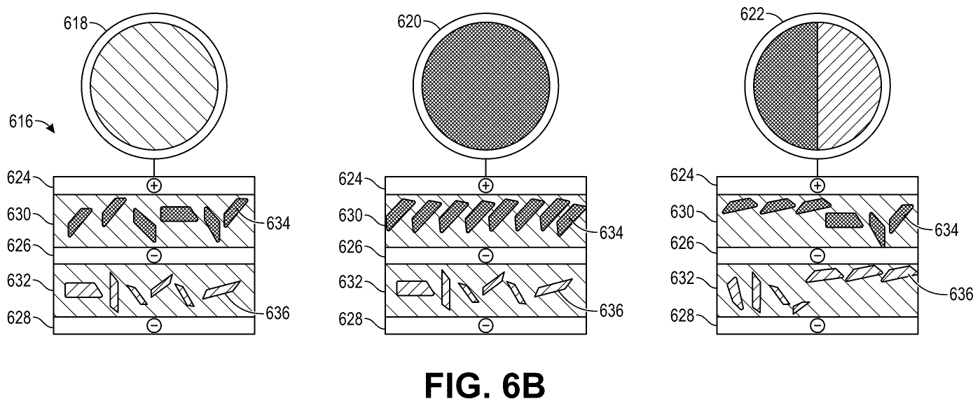

FIGS. 6A-6B are schematics depicting a cross-sectional diagram of the operation of electrophoretic displays, in accordance with the present disclosure. An electrophoretic display system 600, as shown in FIG. 6A, includes a single layer where the display can be observed or configured to exhibit the display in a first state 602, which is depicted as black, the display in a second state 604, which exhibits a certain amount of reflective appearance, or sparkle effect, and the display in a third state 606, which is shown in a different appearance or intensity of a reflective appearance, or sparkle effect. The electrophoretic display system 600 also includes a transparent electrode on an external surface 608 and an electrode on an internal surface 610. Each of these transparent electrodes can be transparent, or translucent, or in some examples, non-transparent. Between the external surface 608 and the internal surface 610 is a fluid media 612 entrained between the two surfaces. Suspended within the fluid media 612 is an electrophoretic material 614, which can include a flake material that has reflective properties when exposed to any light source. FIG. 6B shows an electrophoretic display system 616 having multiple layers, with the display in a first state 618, the display in a second state 620, and the display in a third state 622. In examples, the display in the second state 620 can exhibit a special effect, or the display in the third state 622 can exhibit a special effect in part of the display, a different special effect or color another portion of the display, or any combination of effects or colors as described herein. A transparent electrode on an external surface 624, a transparent electrode on a middle surface 626 and a transparent electrode on an internal surface 628 include a first fluid media 630 entrained between the first transparent electrode on an external surface 624 and the third transparent electrode on a middle surface 626 and a second fluid media 632 entrained between the second transparent electrode on an internal surface 628 and the third transparent electrode on a middle surface 626. A first electrophoretic material 634 is suspended within the first fluid media 630 and a second electrophoretic material 636 is suspended within the second fluid media 632.

The system for providing a display inside a vehicle, as described above can include an electrophoretic surface integrated into an internal component of a vehicle, the electrophoretic surface including a first surface, the first surface including a transparent electrode on the first, external surface 608. The second surface 610 can also include an electrode, which can be transparent, or alternatively non-transparent. This electrode is located on an internal surface 610 and this second surface is parallel to the first, external surface 608 in at least a portion of the entire electrophoretic surface. The first fluid media 612 fills the space between the first surface 608 and the second surface 610, and a first electrophoretic material 614 suspended in the first fluid media 612. The first electrophoretic material 614 has an aspect ratio of from about 10 to about 70 or from about 10:1 to about 100:1. In operation, the system for providing the display includes an electronic controller communicatively coupled to the electrophoretic surface, such that it can induce different states of rotation and/or appearance for the first electrophoretic material 614. The first surface can be integrated as a singular component with an electrode, or it can be in contact with an electrode, such that it is configured to apply a voltage to the first surface for inducing motion to the first electrophoretic material 614. One or both of the first or second surface can be composed of a transparent material. Exemplary transparent materials can include, but are not limited to, indium tin oxide (ITO), other transparent conductive oxides (TCOs), such as conductive polymers, metal grids, and random metallic networks, carbon nanotubes (CNT), graphene, nanowire meshes or ultra thin metal films.

The system for providing a display inside a vehicle includes a third surface 626 that is parallel to the first surface 624 and the second surface 628 in at least a cross-sectional portion of electrophoretic surface 616, and is positioned in between the first surface 624 and the second surface 628. The second fluid media 632 fills a space between the second surface and the third surface, and a second electrophoretic material 636 is suspended in the second fluid media 632. In examples, the second electrophoretic material 636 is different from the first electrophoretic material 634. In examples, any of the first, second, or third surfaces comprise a transparent material, a non-transparent material, or a translucent or partially transparent material. In examples, the fluid media can be composed of glycerin, water, or a combination thereof. A viscosity of any of the fluid media can be from about to about 1 cP to about 10,000 cP. In examples, the fluid media can be colorless, or alternatively colored, or dyed, such that it exhibits a colored appearance. In examples, the electrophoretic materials 614, 634, 636 can be flake-shaped and has an aspect ratio of from about 10 to about 70 or from about 10:1 to about 100:1.

In any of the examples, the first or second electrophoretic material exhibits a variable reflectance towards the external surface that is dependent on an angle of view/angle of a flat plane of the first electrophoretic material as compared to the angle of the external surface. In other examples of the system for providing a display, a front lit display can be configured to direct illumination towards an external side of the surface and is external to the system. In other examples a back lit display can be included that is configured to direct illumination towards an external surface and is integrated into the system and in contact with the first surface. In some instances the space between the first surface and the second surface, or between the second surface and third surface, or between the first surface or the third surface is non-continuous in a direction lateral to the first surface and the second surface. In some examples, the space between the second surface and the third surface is non-continuous in a direction lateral to the second surface and the third surface.

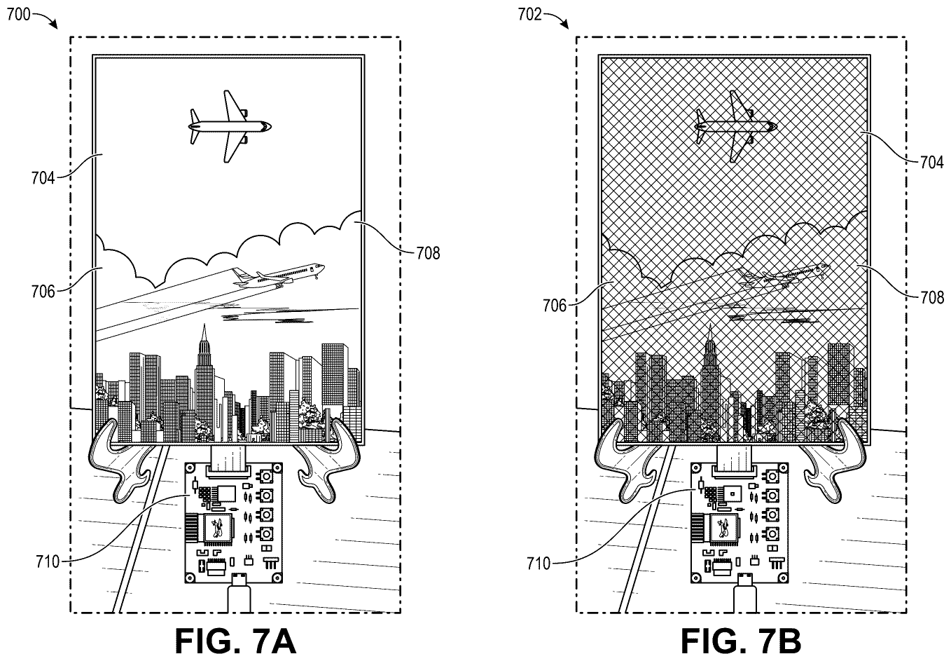

FIGS. 7A-7B are schematics depicting exemplary examples of electrophoretic displays, in accordance with the present disclosure. FIG. 7A shows an electrophoretic display system 700 showing a first electrophoretic display portion 704 and a second electrophoretic display portion 706. The first electrophoretic display portion 704 can include a different electrophoretic pigment from the second electrophoretic display portion 706 or be composed of a filter or opaque panel over the second electrophoretic display portion 706. The appearance of the first electrophoretic display portion 704 or the second electrophoretic display portion 706 can be changed upon communication with the circuit board 710 which can alternatively be configured to rotate electrophoretic materials within the first electrophoretic display portion 704 or the second electrophoretic display portion 706 or both. Likewise, the first electrophoretic display portion 704 or the second electrophoretic display portion 706 can include colored pigments or be configured to display special effects, such as sparkle, glitter, or reflectance, as described herein. FIG. 7B shows another electrophoretic display system 702 having a first electrophoretic display portion 704, a second electrophoretic display portion 706, and a third electrophoretic display portion 708 connected to a circuit board 710. Either of the first electrophoretic display portion 704, the second electrophoretic display portion 706, or the third electrophoretic display portion 708 can include one or more layers, be composed of one or more electrophoretic materials, or include one or more filters to display various special effects or decorative features as described herein.

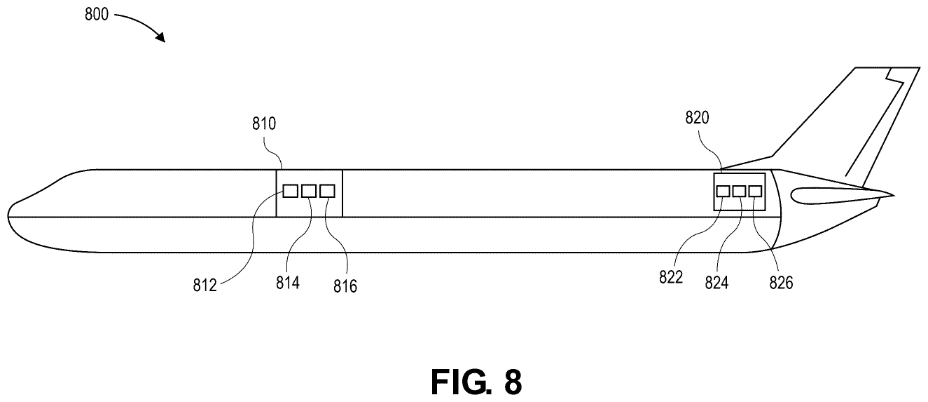

In some examples, an electrophoretic display can be applied to an external portion or surface of a vehicle 800 from the environment. FIG. 8 illustrates a schematic view of a vehicle 800, according to an implementation. As shown, the vehicle 800 may be or include an airplane. The vehicle 800 may also or instead include other types of aircrafts such as helicopters, unmanned aerial vehicles (UAVs), spacecrafts, marine crafts, or the like. In other implementations, the vehicle 800 may be or include a car, a boat, a train, or the like. In still other implementations, the system and methods described herein may not be implemented in a vehicle, and rather may be implemented in a building. The vehicle 800 may include one or more locations (one is shown: 810). The first location 810 may include various electrophoretic displays 812, 814, 816. The vehicle 800 may also include one or more additional electrophoretic displays 822, 824, 826 in a second location 820.

The present disclosure further provides a method of providing a display inside a vehicle, the method including providing an electrophoretic surface integrated into an internal component of the vehicle the electrophoretic surface comprising a first surface, a second surface that is parallel to the first surface in at least a portion of electrophoretic surface, a first fluid media filling a space between the first surface and the second surface, and an first electrophoretic material suspended in the first fluid media, providing an electronic controller communicatively coupled to the electrophoretic surface, and inducing a voltage in the fluid media using the electronic controller, and rotating the electrophoretic material within the fluid media within the vehicle. In examples of the present method, the steps of stopping inducing a voltage in the fluid media using the electronic controller and stopping rotating the electrophoretic material within the fluid media can be employed. In other examples, the display includes a light source provided to a back side of the electrophoretic surface. In other examples, the display can include a light source that is provided to a front side of the electrophoretic surface.

Certain examples can be performed using a computer program or set of programs. The computer programs can exist in a variety of forms both active and inactive. For example, the computer programs can exist as software program(s) comprised of program instructions in source code, object code, executable code or other formats; firmware program(s), or hardware description language (HDL) files. Any of the above can be embodied on a transitory or non-transitory computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), flash memory, and magnetic or optical disks or tapes.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented using computer readable program instructions that are executed by an electronic processor.

These computer readable program instructions may be provided to a processor of a general-purpose computer, special purpose computer, or other programmable data processing apparatus to produce a machine, such that the instructions, which execute via the electronic processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

In embodiments, the computer readable program instructions may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the C programming language or similar programming languages. The computer readable program instructions may execute entirely on a user's computer, partly on the user's computer, as a stand-alone software package, partly on the user's computer and partly on a remote computer or entirely on the remote computer or server.

As used herein, the terms “A or B” and “A and/or B” are intended to encompass A, B, or {A and B}. Further, the terms “A, B, or C” and “A, B, and/or C” are intended to encompass single items, pairs of items, or all items, that is, all of: A, B, C. {A and B}, {A and C}, {B and C}, and {A and B and C}. The term “or” as used herein means “and/or.”

As used herein, language such as “at least one of X, Y, and Z,” “at least one of X, Y, or Z.” “at least one or more of X, Y, and Z.” “at least one or more of X, Y, or Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X. Y, and Z}). The phrase “at least one of” and similar phrases are not intended to convey a requirement that each possible item must be present, although each possible item may be present.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. § 112 (f). However, for any claims containing elements designated in any other manner, it is intended that such elements are not to be interpreted under 35 U.S.C. § 112 (f).

While the invention has been described with reference to the exemplary examples thereof, those skilled in the art will be able to make various modifications to the described examples without departing from the true spirit and scope. The terms and descriptions used herein are set forth by way of illustration only and are not meant as limitations. In particular, although the method has been described by examples, the steps of the method can be performed in a different order than illustrated or simultaneously. Those skilled in the art will recognize that these and other variations are possible within the spirit and scope as defined in the following claims and their equivalents.

What is claimed is:

1. A system for providing a display inside a vehicle, comprising:
an electrophoretic surface integrated into an internal component of a vehicle, the electrophoretic surface comprising:
a first surface;
a second surface that is parallel to the first surface in at least a portion of electrophoretic surface;
a first fluid media filling a space between the first surface and the second surface; and
a first electrophoretic material suspended in the first fluid media; wherein the first electrophoretic material has an aspect ratio of from about 10:1 to about 100:1; and
an electronic controller communicatively coupled to the electrophoretic surface.

2. The system of claim 1, wherein the first surface in contact with an electrode, configured to apply a voltage to the first surface.

3. The system of claim 1, wherein the second surface comprises a transparent material.

4. The system of claim 1, further comprising:
a third surface that is parallel to the first surface and the second surface in at least a cross-sectional portion of electrophoretic surface;
a second fluid media filling a space between the second surface and the third surface; and
a second electrophoretic material suspended in the second fluid media.

5. The system of claim 4, wherein the second electrophoretic material is different from the first electrophoretic material.

6. The system of claim 4, wherein the third surface comprises a transparent material.

7. The system of claim 1, wherein the first fluid media comprises glycerin, water, or a combination thereof.

8. The system of claim 1, wherein a viscosity of the first fluid media is from about to about 1 cP to about 10,000 cP.

9. The system of claim 1, wherein the first fluid media is colorless.

10. The system of claim 1, wherein the first electrophoretic material exhibits a variable reflectance towards the second surface that is dependent on an angle of view or an angle of a flat plane of the first electrophoretic material as compared to the angle of the second surface, thereby creating a glitter effect or a sparkle effect.

11. The system of claim 1, further comprising a front lit display that is configured to direct illumination towards an external side of the second surface and is external to the system.

12. The system of claim 1, further comprising a back lit display that is that is configured to direct illumination towards an external surface of the first surface and is integrated into the system and in contact with the first surface.

13. The system of claim 1, wherein the space between the first surface and the second surface is non-continuous in a direction lateral to the first surface and the second surface.

14. The system of claim 4, wherein the space between the second surface and the third surface is non-continuous in a direction lateral to the second surface and the third surface.

15. The system of claim 4, wherein:
the first electrophoretic material is flake-shaped and has an aspect ratio of from about 10 to about 70; and
the second electrophoretic material is flake-shaped and has an aspect ratio of from about 10 to about 70.

16. The system of claim 1, wherein the vehicle is an aerospace vehicle.

17. A method of providing a display inside a vehicle, the method comprising:
providing an electrophoretic surface integrated into an internal component of the vehicle the electrophoretic surface comprising a first surface, a second surface that is parallel to the first surface in at least a portion of electrophoretic surface, a first fluid media filling a space between the first surface and the second surface, and an first electrophoretic material suspended in the first fluid media;
providing an electronic controller communicatively coupled to the electrophoretic surface; and
inducing a voltage in the fluid media using the electronic controller; and rotating the electrophoretic material within the fluid media within the vehicle.

18. The method of providing a display inside a vehicle of claim 17, further comprising:
stopping inducing a voltage in the fluid media using the electronic controller; and
stopping rotating the electrophoretic material within the fluid media.

19. The method of providing a display inside a vehicle of claim 17, further comprising providing a light source to a back side of the electrophoretic surface.

20. The method of providing a display inside a vehicle of claim 17, further comprising providing a light source to a front side of the electrophoretic surface.
